(19) United States
(12) Patent Application Publication
(10) Pub. No.: US 2017/0018850 A1
(43) Pub. Date: Jan. 19, 2017

(54) HORN ANTENNA APPARATUS

(71) Applicant: ELECTRONICS AND TELECOMMUNICATIONS RESEARCH INSTITUTE, Daejeon (KR)

(72) Inventors: So Hyeun YUN, Daejeon (KR); Chang Soo KWAK, Daejeon (KR); Man Seok UHM, Daejeon (KR); In Bok YOM, Daejeon (KR); Hong Yeol LEE, Daejeon (KR)

(73) Assignee: ELECTRONICS AND TELECOMMUNICATIONS RESEARCH INSTITUTE, Daejeon (KR)

(21) Appl. No.: 15/160,120

(22) Filed: May 20, 2016

(30) Foreign Application Priority Data
Jul. 17, 2015 (KR) 10-2015-0101881

(51) Int. Cl. H01Q 13/02; H01Q 5/50

(52) U.S. Cl. CPC H01Q 13/025; H01Q 5/50

(57) ABSTRACT

The present disclosure relates to a horn antenna apparatus. The horn antenna apparatus includes: a first horn antenna; and a second horn antennas provided with an input waveguide which is arranged to correspond to an output waveguide of the first horn antenna, wherein the output waveguide of the first horn antenna and the input waveguide of the second horn antenna are connected to be overlapped with each other to form a mode conversion waveguide, and higher modes of a TM11 mode and a TE12 mode are generated in an aperture of an output waveguide of the second horn antenna.

### CROSS-REFERENCE TO RELATED APPLICATION

This application claims the benefit of priority to Korean Patent Application No. 10-2015-0101881, filed on Jul. 17, 2015 in the Korean Intellectual Property Office, the disclosure of which is incorporated herein in its entirety by reference.

### BACKGROUND OF THE INVENTION

Field of the Invention

The present disclosure relates to a horn antenna apparatus.

Description of the Related Art

A multi-beam antenna requiring high directivity or a shaped beam antenna for a flexible beam forming mainly uses an array structure using a plurality of horn antennas. In order to reduce the volume of an array structure antenna, the size of the horn antenna should be minimized.

In some cases, a conical horn shape having an extended aperture is used in order to improve the directivity. As the slope of a slope region of a conical horn becomes sharper, that is, the length of the horn becomes shorter, it is difficult to form a plane wave in the aperture, so that a phase error due to a spherical wave occurs. When the aperture of the conical horn is increased or the length of the horn is decreased, the phase error of spherical wave is increased and the loss is increased. Thus, the antenna gain due to the loss is reduced and the variation of a phase center point according to a frequency is increased.

When the horn aperture is enlarged by the slope of the conical horn, the antenna gain may be increased, and antenna efficiency is determined by a ratio of occurred higher mode.

The conventional conical horns have been used multiple steps with a gentle slope so as to increase the antenna efficiency, so that TM modes are suppressed in the horn aperture and only TE modes are generated.

However, in order to suppress higher TM modes the phase of each TM mode should be anti-phase thru the guide wavelength and it results in extending the length of the horn as over 180 degrees.

### SUMMARY OF THE INVENTION

The present disclosure has been made in view of the above problems, and provides a horn antenna apparatus which consecutively arranges and overlaps a plurality of conical horns without a step structure.

The present disclosure further provides a horn antenna apparatus which improves an efficiency of antenna by utilizing TM modes generated as higher modes.

In accordance with an aspect of the present disclosure, a horn antenna apparatus includes: a first horn antenna; and a second horn antennas provided with an input waveguide which is arranged to correspond to an output waveguide of the first horn antenna, wherein the output waveguide of the first horn antenna and the input waveguide of the second horn antenna are connected to be overlapped with each other to form a mode conversion waveguide, and higher modes of a TM11 mode and a TE12 mode are generated in an aperture of an output waveguide of the second horn antenna. A shape and an electrical characteristic of the horn antenna apparatus are determined based on the input waveguide diameter of the first horn antenna, the mode conversion waveguide, and the output waveguide of the second horn antenna, and a length of the horn antenna apparatus. The TM11 mode in the aperture of the output waveguide in the second horn antenna has a phase difference of 50 degrees with a TE11 mode in the aperture of the input waveguide of the first horn antenna. A length of the waveguide having a phase difference of 50 degrees between the TM11 mode and the TE11 mode is calculated by using a following Equation

$$\frac{𝓁}{{λ}_{g}^{TE 11}} - \frac{𝓁}{{λ}_{g}^{TM 11}} = - \frac{5}{36}$$

(where λg is a wavelength in the waveguide according to each mode, and l is a length of the mode conversion waveguide for a phase control of each mode). The TE12 mode in the aperture of the output waveguide of the second horn antenna has a phase difference of 150 degrees with a TE11 mode in the aperture of the input waveguide of the first horn antenna. A length of the waveguide having a phase difference of 150 degrees between the TE12 mode and the TE11 mode is calculated by using a following Equation

$$\frac{𝓁}{{λ}_{g}^{TE 11}} - \frac{𝓁}{{λ}_{g}^{TE 12}} = \frac{5}{12}$$

(where λg is a wavelength in the waveguide according to each mode, and l is a length of the mode conversion waveguide for a phase control of each mode). The TE12 mode in the aperture of the output waveguide of the second horn antenna has a phase difference of 200 degrees with the TM11 mode in the aperture of the output waveguide of the second horn antenna. A length of the waveguide having a phase difference of 200 degrees between the TM11 mode and the TE12 mode is calculated by using a following Equation

$$\frac{𝓁}{{λ}_{g}^{TM 11}} - \frac{𝓁}{{λ}_{g}^{TE 12}} = \frac{4}{9}$$

(where λg is a wavelength in the waveguide according to each mode, and l is a length of the mode conversion waveguide for a phase control of each mode). A diameter of the aperture of the output waveguide of the second horn antenna is calculated by using a following Equation

$$d = \frac{\sqrt{4 {k}_{TE 12}^{2} - {k}_{TM 11}^{2}}}{π \sqrt{3}} {λ}_{0}$$

(wherein, d is a diameter of the aperture, λ0 is a wavelength in a free space, and k is a root of the derivative of Bessel function according to each mode). A phase constant of the TM11 mode in the aperture of the output waveguide of the second horn antenna is determined to be twice a phase constant of the TE12 mode.

### BRIEF DESCRIPTION OF THE DRAWINGS

The objects, features and advantages of the present disclosure will be more apparent from the following detailed description in conjunction with the accompanying drawings, in which:

FIG. 1 is a diagram illustrating a configuration of a horn antenna apparatus according to an embodiment of the present disclosure;

FIG. 2 is a diagram illustrating an electric field distribution in H-plane of a horn antenna apparatus according to an embodiment of the present disclosure;

FIG. 3 is a diagram illustrating an electric field distribution for a phase of a horn antenna apparatus according to an embodiment of the present disclosure;

FIG. 4 is a diagram illustrating a modal amplitude required for a horn antenna apparatus according to an embodiment of the present disclosure;

FIG. 5 is a diagram illustrating a modal phase required for a horn antenna apparatus according to an embodiment of the present disclosure;

FIG. 6 is a diagram illustrating an antenna efficiency and a pattern of a horn antenna apparatus according to an embodiment of the present disclosure; and

FIG. 7 is a diagram illustrating a phase center of a normalized frequency of a horn antenna apparatus according to an embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The present disclosure relates to a horn antenna apparatus. When the horn antenna apparatus is used as an array element for multi-beam or beam forming, the efficiency of a unit element should be high and the volume should be small. The horn antenna apparatus of the present disclosure utilizes a conical horn antenna that has an extended aperture.

Since the conical horn antenna generates a phase error caused by a spherical wave, the antenna efficiency is reduced. Accordingly, in order to increase the antenna efficiency, the phase error of spherical wave in the aperture should be reduced and an electric field distribution should be uniformly generated. Thus, the present disclosure provides a horn antenna apparatus that increases the antenna efficiency by utilizing a TM mode generated as a higher mode.

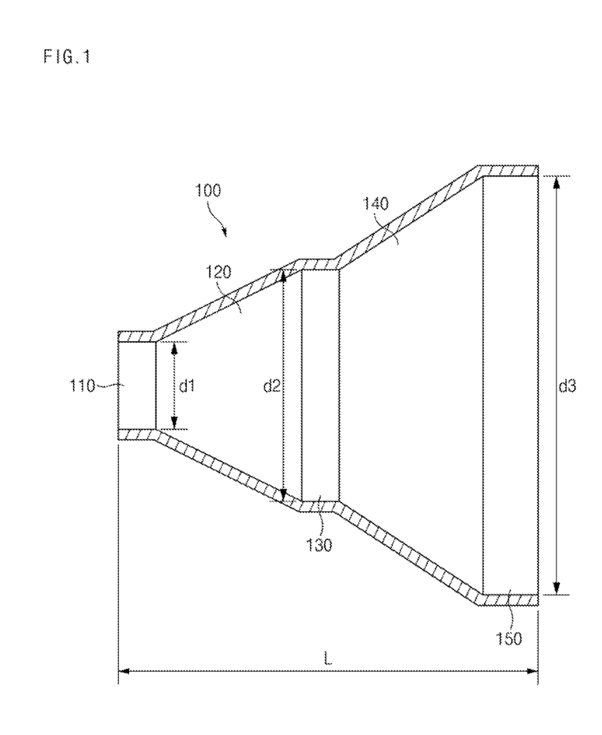

FIG. 1 is a diagram illustrating a configuration of a horn antenna apparatus according to an embodiment of the present disclosure.

The horn antenna apparatus 100 according to an embodiment of the present disclosure has a structure in which conical horns are consecutively arranged and overlapped without a step structure.

FIG. 1 illustrates a structure in which two conical horns are overlapped, but it is just an exemplary embodiment and more conical horns may be consecutively arranged and overlapped depending on an embodiment.

Thus, as shown in FIG. 1, the horn antenna apparatus 100 according to the present disclosure may include a first horn antenna and a second horn antenna which is arranged such that an input waveguide corresponds to an output waveguide of the first horn antenna. Here, the output waveguide of the first horn antenna and an output waveguide of the second horn antenna may be connected to be overlapped with each other, which may form a single mode conversion waveguide unit 130.

Thus, the horn antenna apparatus 100 having a form in which the first horn antenna and the second horn antenna are overlapped with each other may be implemented with a structure having an input waveguide unit 110, a first horn waveguide unit 120, a mode conversion waveguide unit 130, a second horn waveguide unit 140, and an output waveguide unit 150. Here, it is assumed that the aperture of the input waveguide unit 110, the first horn waveguide unit 120, the mode conversion waveguide unit 130, the second horn waveguide unit 140, and the output waveguide unit 150 is circular in shape. However, the shape of the aperture may vary depending on an embodiment.

The input waveguide unit 110 may correspond to the input waveguide of the first horn antenna, and an internal height and width may be uniformly formed in a longitudinal direction. At this time, the input waveguide unit 110 may serve to receive electromagnetic waves caused by a unique mode and transmit to the inner horn antenna apparatus 100. For example, the input waveguide unit 110 may progress a radio wave in a TE11 mode.

The first horn waveguide unit 120 may have a horn shape that has height and width which gradually increase as it proceeds from the input side aperture to the output side aperture, and may correspond to the horn of the first horn antenna. At this time, the input side aperture of the first horn waveguide unit 120 may be in contact with the output side aperture of the input waveguide unit 110, and the output side aperture may be in contact with the input side aperture of the mode conversion waveguide unit 130.

The first horn waveguide unit 120 may serve to match the impedance of radio signal between the input waveguide unit 110 and the mode conversion waveguide unit 130.

The mode conversion waveguide unit 130 may be formed by connecting the output waveguide of the first horn antenna and the output waveguide of the second horn antenna to be overlapped with each other. At this time, the input side aperture of the mode conversion waveguide unit 130 may be in contact with the output side aperture of the first horn waveguide unit 120, and the output side aperture of the mode conversion waveguide unit 130 may be in contact with the input side aperture of the second horn waveguide unit 140. The internal height and width of the mode conversion waveguide unit 130 may be uniformly formed in the longitudinal direction.

The mode conversion waveguide unit 130 may be disposed between the first horn waveguide unit 120 and the second horn waveguide unit 140, so that an impedance matching signal is transmitted through the first horn waveguide unit 120. Here, a current distribution may be formed in the output side aperture of the mode conversion waveguide unit 130 due to a mutual electromagnetic wave coupling in the waveguide of the first horn waveguide unit 120. In this case, a Transverse Electro (TE) mode or a Transverse Magnetic (TM) mode may occur in the input side aperture of the mode conversion waveguide unit 130 while passing through the first horn waveguide unit 120. As an example, a TE12 mode and a TM11 mode may occur in the input side aperture of the mode conversion waveguide unit 130.

Here, the TE mode refers to a mode of forming an electrical transverse wave which has magnetic field component H in the moving direction but has no electric field component E from among electromagnetic waves transmitted along the waveguide. The TM mode refers to a mode of forming a magnetic transverse wave which has electric field component E in the moving direction but has no magnetic field component H.

At this time, the mode conversion waveguide unit 130 may control the phase of each mode progressed in the inside.

The second horn waveguide unit 140 may have a horn shape that has height and width which gradually increase as it proceeds from the input side aperture to the output side aperture, and may correspond to the horn of the second horn antenna. At this time, the input side aperture of the second horn waveguide unit 140 may be in contact with the output side aperture of the mode conversion waveguide unit 130, and the output side aperture may be in contact with the input side aperture of the output waveguide unit 150.

The second horn waveguide unit 140 may serve to match the impedance of radio signal between the mode conversion waveguide unit 130 and the output waveguide unit 150.

The input side aperture of the output waveguide unit 150 may be in contact with the output side aperture of the second horn waveguide unit 140, and the internal height and width may be uniformly formed in the longitudinal direction. The output waveguide unit 150 may correspond to the output waveguide of the second horn antenna. At this time, the output waveguide unit 150 may serve to radiate a radio signal of the higher mode transmitted from the second horn waveguide unit 140.

An impedance matching signal may be transmitted to the output waveguide unit 150 through the second horn waveguide unit 140. Here, a current distribution may be formed in the output side aperture of the mode conversion waveguide unit 130 due to a mutual electromagnetic wave coupling in the waveguide of the second horn waveguide unit 140. In this case, a higher mode, such as the TM11 mode and the TE12 mode, may occur in the final aperture of the output waveguide unit 150.

At this time, the shape and the electrical characteristic of the horn antenna apparatus 100 may be determined according to the diameter of the aperture of the input waveguide unit 110, the mode conversion waveguide unit 130, and the output waveguide unit 150, and the length of the horn antenna apparatus 100.

The first horn waveguide unit 120 and the second horn waveguide unit 140 may form a current distribution in the output side aperture due to a mutual electromagnetic wave coupling in the moving direction of radio signal in the waveguide.

Accordingly, the first horn waveguide unit 120 and the second horn waveguide unit 140 may progress the TM11 mode and the TE12 mode in the output side aperture. In this case, the TM11 mode in the final aperture of the horn antenna apparatus 100 may have a phase difference of 50 degrees with the TE11 mode.

The length of the mode conversion waveguide unit 130 for the phase difference of 50 degrees between the TE11 mode and the TM11 mode may be calculated approximately using the following Equation 1.

$$\frac{𝓁}{{λ}_{g}^{TE 11}} - \frac{𝓁}{{λ}_{g}^{TM 11}} = - \frac{5}{36} \qquad [ Equation 1 ]$$

In Equation 1, λg is a wavelength in the waveguide according to each mode, and l is a length of the mode conversion waveguide unit 130 for a phase control of each mode. Here, since the length of the mode conversion waveguide unit 130 is required only to an extent of generating a phase difference of 50 degrees, the length of the mode conversion waveguide unit 130 may be reduced.

Meanwhile, the TE12 mode which is the higher mode has a phase difference of 150 degrees with the TE11 mode, and has a phase difference of 200 degrees with the TM11 mode. At this time, the length of the mode conversion waveguide unit 130 for implementing the TE12 mode may be calculated approximately through the following Equation 2 and Equation 3.

$$\begin{matrix}\frac{𝓁}{{λ}_{g}^{TE 11}} - \frac{𝓁}{{λ}_{g}^{TE 12}} = \frac{5}{12} & [ Equation 2 ] \\ \frac{𝓁}{{λ}_{g}^{TM 11}} - \frac{𝓁}{{λ}_{g}^{TE 12}} = \frac{4}{9} & [ Equation 3 ]\end{matrix}$$

In Equation 2 and Equation 3, λg is a wavelength in the waveguide according to each mode, and l is a length of the mode conversion waveguide unit 130 for the phase control in each mode. Here, the length of the mode conversion waveguide unit 130 is required only to an extent of generating a phase difference of 50 degrees.

In order to obtain such a phase difference, it is influenced by the diameter d2 of the aperture of the mode conversion waveguide unit 130 for the TE12 mode.

The diameter d2 of the aperture of the mode conversion waveguide unit 130 may be the diameter of the output side aperture of the first horn antenna and, at the same time, may be the diameter of the input side aperture of the second horn antenna.

Here, the diameter d2 of the aperture of the mode conversion waveguide unit 130 may be determined in such a manner that the phase constant of the TM11 mode is twice the phase constant of the TE12 mode. In this case, the wavelength (λ_{TM11}, λ_{TE12}) in the wave guide of each mode may be inversely proportional to the phase constant (β_{TM11}, β_{TE12}) of each mode.

For example, the relationship between the wavelength (λ_{TM11}) and the phase constant (β_{TM11}) in the wave guide of TM11 mode may be represented as the following Equation 4.

$${λ}_{g}^{TM 11} = \frac{2 π}{{β}_{TM 11}} \qquad [ Equation 4 ]$$

At this time, the phase constant (βTM11, (βTE12) of each mode may be related to a cut-off frequency (kc.TM11, kc.TE12) of each mode, and the cut-off frequency may be influenced by the Bessel function or the root (kTM11, kTE12) of the derivative of Bessel function.

For example, the relationship of the phase constant (βTM11) of the TM11 mode, the cut-off frequency (kc.TM11), the Bessel functions or the root (kTM11) of the derivative of Bessel function may be represented as the following Equation 5.

$${β}_{TM 11} = \sqrt{{k}^{2} - {k}_{c , TM 11}^{2}} = \sqrt{{( \frac{2 π}{{λ}_{0}} )}^{2} - {( \frac{{k}_{TM 11}}{a} )}^{2}} \qquad [ Equation 5 ]$$

In Equation 5, λ0 denotes a wavelength in free space.

When using Equation 5, Equation for the diameter d of the aperture of the mode conversion waveguide unit 130 may be expressed as follows.

$$\begin{matrix}{λ}_{g}^{TM 11} = \frac{1}{2} {λ}_{g}^{TE 12} & [ Equation 6 ] \\ d = \frac{\sqrt{4 {k}_{TE 12}^{2} - {k}_{TM 11}^{2}}}{π \sqrt{3}} {λ}_{0} & [ Equation 7 ]\end{matrix}$$

As an example, the diameter d of the aperture of the mode conversion waveguide unit 130 may be approximately 1.83λ0. At this time, the diameter of the aperture of the mode conversion waveguide unit 130 may be not sufficient to generate a higher mode, but it is possible to generate a desired higher mode such as the TM11 mode and the TE12 mode in the output waveguide unit 150 if it passes through the second horn waveguide unit 140.

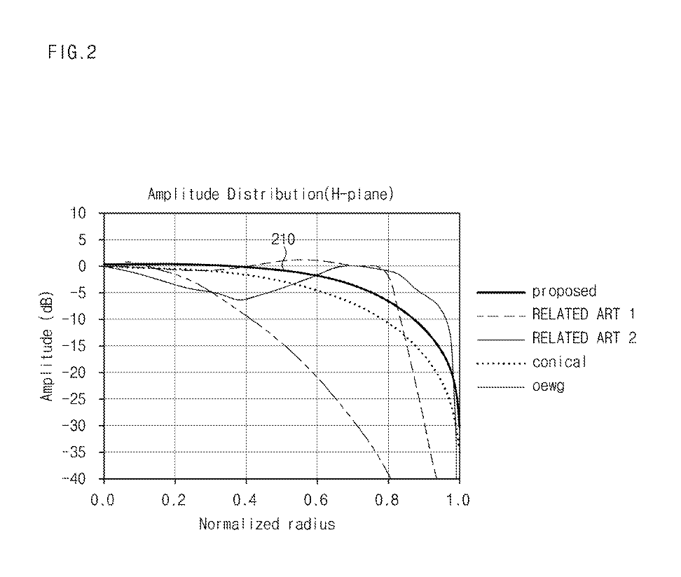

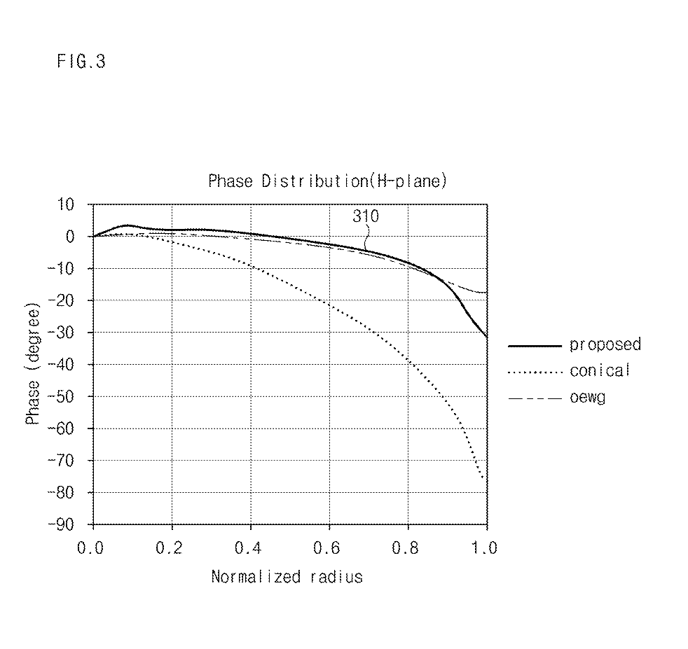

FIG. 2 is a diagram illustrating an electric field distribution for a H-plane of a horn antenna apparatus according to an embodiment of the present disclosure, and FIG. 3 is a diagram illustrating an electric field distribution for a phase of a horn antenna apparatus according to an embodiment of the present disclosure.

Referring to FIG. 2, an increased antenna efficiency of the horn antenna apparatus may be obtained by making the electric field distribution in the aperture to be uniform. When inputting a X-axis polarized wave to the horn antenna apparatus, a relatively uniform electric field distribution is shown in E-plane and a variable electric field distribution is shown in H-plane.

FIG. 2 illustrates an electric field distribution for a H-plane when a X-axis polarized wave is input to the antenna, and compares the horn antenna apparatus according to an embodiment of the present disclosure with a conventional antenna. In FIG. 2, a horizontal axis indicates a normalized size of the aperture, a central axis of the aperture is indicated as 0, and an edge of the aperture is indicated as 1.

In the case of an open-ended waveguide (“oewg”), its size may be identical with the size of the input aperture of the horn antenna apparatus of the present disclosure, and, at this time, it can be determined that the H-plane drops suddenly in the vicinity of the center of the aperture.

Meanwhile, the size of the output aperture of the conical horn antenna may be identical with the size of the output aperture of the horn antenna apparatus of the present disclosure, and, in this case, it can be determined that only 60% of the output aperture area is uniform based on −5 dB.

In addition, a related art 1 and a related art 2 may be an antenna which removed the TM mode in the higher mode, and have an electric field distribution which is uniform in about 80% and 90% of the aperture. However, in the case of the related art 1 and the related art 2, it can be determined that an electric field amplitude distribution varies in the vicinity of the center of the aperture.

In the case of the present disclosure (“proposed”), it can be determined that the electric field amplitude distribution is uniform in about 78% of the aperture in a uniform electric field amplitude distribution graph 210.

Referring to FIG. 3, an electric field phase distribution graph 310 according to the present disclosure shows that a phase is also uniform in the vicinity of the center of the aperture as well as the amplitude of the electric field distribution.

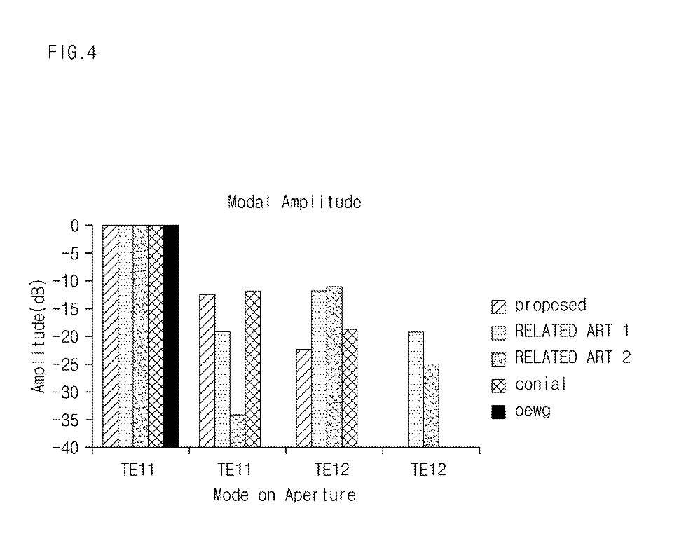

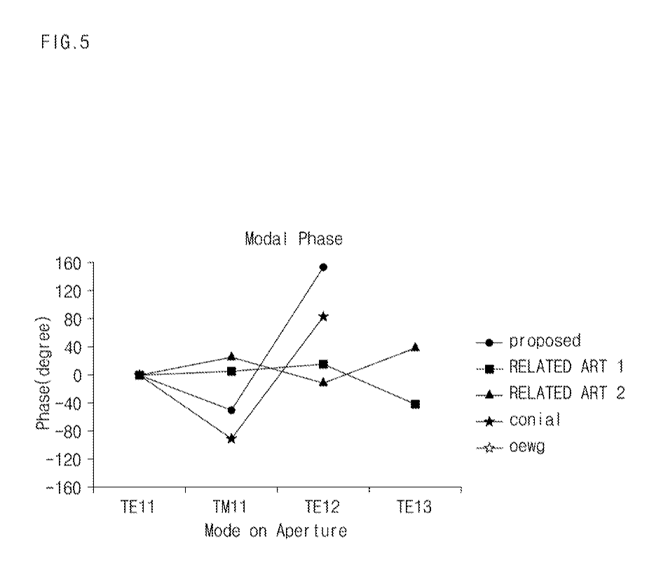

FIG. 4 is a diagram illustrating a modal amplitude required for a horn antenna apparatus according to an embodiment of the present disclosure, and FIG. 5 is a diagram illustrating a modal phase required for a horn antenna apparatus according to an embodiment of the present disclosure.

The amplitude and phase of each mode required for the horn antenna apparatus according to an embodiment of the present disclosure may be based on the input TE11 mode.

A progress mode of radio signal and a block mode may be determined by the size of the aperture. In the open-ended waveguide (“oewg”), all input TE11 mode may be transmitted to the aperture and a higher mode does not occur. The conical horn (“conical”) may progress the TM11 mode and the TE12 mode in the aperture, and the higher mode, over TE12, may become the block mode due to the size of the aperture. The phase of each mode due to the conical horn may become −90 degrees, +90 degrees in comparison with the TE11 mode, so that both of two modes may be involved in the electric field distribution of aperture.

Meanwhile, the related art 1 and the related art 2 may decrease the size of the TM11 mode as much as possible and may increase the size of the TE12 mode as much as possible so as to remove the TM11 mode. At this time, the phase of each mode may be maintained to keep the same phase as the TE11 mode. Here, since the aperture of an antenna according to the related art 1 and the related art 2 is approximately 4λ0, it proceeds to the TE13 mode, and the size of the TE13 mode may be increased as much as possible so as to increase the efficiency of the antenna.

The TM11 mode and the TE12 mode may be generated in the aperture of the horn antenna apparatus according to an embodiment of the present disclosure, and may have the same progress mode as it has the same aperture size as the conical horn. At this time, the horn antenna apparatus according to an embodiment of the present disclosure may not remove the TM11 mode, but may have a phase difference of 50 degrees between the phase of the TM11 mode and the phase of the TE11 mode.

In this case, the length of waveguide necessary for the mode conversion in the horn antenna apparatus of the present disclosure is required only to the extent that the phase difference is 50 degrees. Therefore, it is possible to reduce the length of the waveguide to about ¼ or less in comparison with the conventional technology.

When reducing the length of the waveguide, the diameter of the aperture may be decreased. However, since the horn antenna apparatus according to the present disclosure has a structure in which at least two horn antennas are consecutively arranged and overlapped, the diameter of the aperture may also be satisfied, and it is possible to generate a desired higher mode in the final aperture.

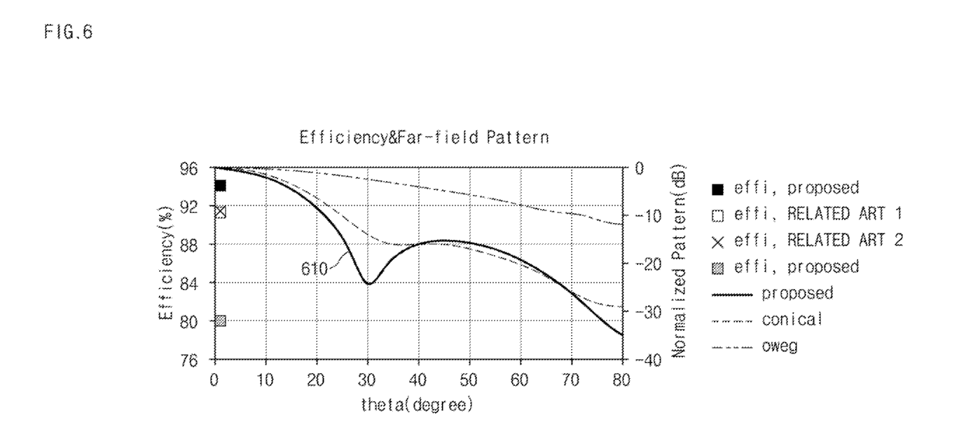

FIG. 6 is a diagram illustrating an antenna efficiency and a pattern of a horn antenna apparatus according to an embodiment of the present disclosure.

Referring to FIG. 6, the present disclosure shows the efficiency and the pattern of the horn antenna apparatus which overlaps the conical horn and utilizes the TM mode of the higher mode. The graph of FIG. 6 has a left y-axis denoting an antenna efficiency, and a right y-axis denoting an antenna pattern. Here, the antenna efficiency may be obtained by calculating a ratio of a maximum gain due to the aperture having uniform size and phase and an actual maximum gain calculated according to the antenna structure.

As shown in the graph of FIG. 6, while the efficiency of the conical horn is 80% and the antenna efficiency of the related art 1 and the related art 2 is 92%, it can be determined that the efficiency of the antenna in the present disclosure is 94%. Thus, when the efficiency of the antenna is high, the directivity of the antenna is improved to reduce a beam width.

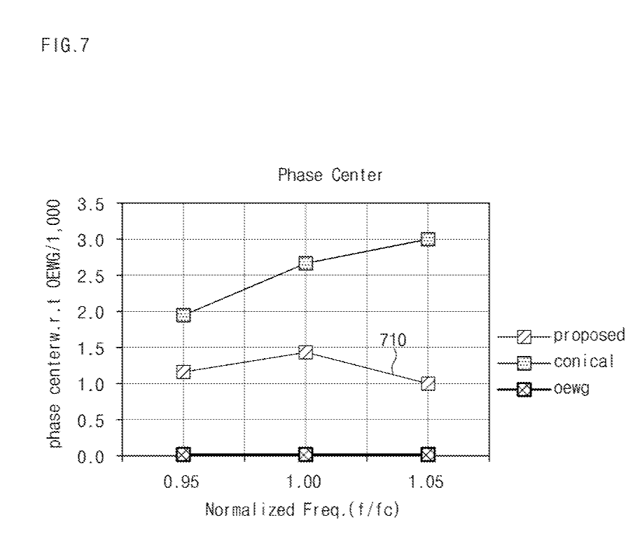

FIG. 7 is a diagram illustrating a phase center of a normalized frequency of a horn antenna apparatus according to an embodiment of the present disclosure.

The horn antenna apparatus according to an embodiment of the present disclosure may utilize the TM11 mode having a phase difference of 50 degrees in comparison with the TE11 mode, and the TE12 mode having a phase difference of 150 degrees, so that it is possible to reduce a phase error in comparison with the conical horn. This may be confirmed through a phase center characteristic shown in FIG. 7.

The embodiment of FIG. 7 illustrates a phase center for a frequency normalized to a center frequency (fc), and a phase center point may be indicated based on the aperture.

The phase center of the horn antenna apparatus according to the present disclosure may be close to the aperture and the phase center point may be constant in a range of fractional band width 10%. Therefore, when the horn antenna apparatus according to the present disclosure is used as an array element or used as a feed horn, the positioning may be easier, and it is advantageous in that it is possible to feed a wave of constant phase in a wide frequency band.

The present disclosure may improve an efficiency of antenna by utilizing a TM mode generated in a higher mode of multi-mode.

The present disclosure may consecutively arrange and overlap a plurality of conical horns without a step structure to reduce the length of the horn antenna apparatus, so that it is possible to minimize the volume of the antenna and reduce the production cost.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A horn antenna apparatus comprising:
a first horn antenna; and
a second horn antennas provided with an input waveguide which is arranged to correspond to an output waveguide of the first horn antenna,
wherein the output waveguide of the first horn antenna and the input waveguide of the second horn antenna are connected to be overlapped with each other to form a mode conversion waveguide, and higher modes of a TM11 mode and a TE12 mode are generated in an aperture of an output waveguide of the second horn antenna.

2. The horn antenna apparatus of claim 1, wherein a shape and an electrical characteristic of the horn antenna apparatus are determined based on the diameter of an input waveguide in the first horn antenna, the mode conversion waveguide, and the output waveguide of the second horn antenna, and a length of the horn antenna apparatus.

3. The horn antenna apparatus of claim 2, wherein the TM11 mode in the aperture of the output waveguide in the second horn antenna has a phase difference of 50 degrees with a TE11 mode in the aperture of the input waveguide of the first horn antenna.

4. The horn antenna apparatus of claim 3, wherein a length of the waveguide having a phase difference of 50 degrees between the TM11 mode and the TE11 mode is calculated by using a following Equation
$$\frac{𝓁}{{λ}_{g}^{TE 11}} - \frac{𝓁}{{λ}_{g}^{TM 11}} = - \frac{5}{36}$$
(where λg is a wavelength in the waveguide according to each mode, and l is a length of the mode conversion waveguide for a phase control of each mode).

5. The horn antenna apparatus of claim 2, wherein the TE12 mode in the aperture of the output waveguide of the second horn antenna has a phase difference of 150 degrees with a TE11 mode in the aperture of the input waveguide of the first horn antenna.

6. The horn antenna apparatus of claim 5, wherein a length of the waveguide having a phase difference of 150 degrees between the TE12 mode and the TE11 mode is calculated by using a following Equation
$$\frac{𝓁}{{λ}_{g}^{TE 11}} - \frac{𝓁}{{λ}_{g}^{TE 12}} = \frac{5}{12}$$
(where λg is a wavelength in the waveguide according to each mode, and l is a length of the mode conversion waveguide for a phase control of each mode).

7. The horn antenna apparatus of claim 2, wherein the TE12 mode in the aperture of the output waveguide of the second horn antenna has a phase difference of 200 degrees with the TM11 mode in the aperture of the output waveguide of the second horn antenna.

8. The horn antenna apparatus of claim 7, wherein a length of the waveguide having a phase difference of 200 degrees between the TM11 mode and the TE12 mode is calculated by using a following Equation
$$\frac{𝓁}{{λ}_{g}^{TM 11}} - \frac{𝓁}{{λ}_{g}^{TE 12}} = \frac{4}{9}$$
(where λg is a wavelength in the waveguide according to each mode, and l is a length of the mode conversion waveguide for a phase control of each mode).

9. The horn antenna apparatus of claim 2, wherein a diameter of the aperture of the output waveguide of the second horn antenna is calculated by using a following Equation
$$d = \frac{\sqrt{4 {k}_{TE 12}^{2} - {k}_{TM 11}^{2}}}{π \sqrt{3}} {λ}_{0}$$
(wherein, d is a diameter of the aperture, λ0 is a wavelength in a free space, and k is a root of the derivative of Bessel function according to each mode).

10. The horn antenna apparatus of claim 2, wherein a phase constant of the TM11 mode in the aperture of the output waveguide of the second horn antenna is determined to be twice a phase constant of the TE12 mode.
